(19) United States
(12) Patent Application Publication
(10) Pub. No.: US 2026/0220341 A1
(43) Pub. Date: Jul. 30, 2026

(54) METHOD AND SYSTEM FOR SIMULATING AN ELECTRONIC CIRCUIT

(71) Applicant: Rohde & Schwarz GmbH & Co. KG, Munich (DE)

(72) Inventors: Julius SEEGER, Prien am Chiemsee (DE); Philipp KURPIERS, Moosburg (DE)

(21) Appl. No.: 19/394,429

(22) Filed: Nov. 19, 2025

(30) Foreign Application Priority Data
Jan. 27, 2025 (DE) 10 2025 102 700.5

(51) Int. Cl. G06F 30/3308; G06F 111/10

(52) U.S. Cl. CPC G06F 30/3308; G06F 2111/10

(57) ABSTRACT

The disclosure relates to a method of simulating an electronic circuit, comprising: modelling the electronic circuit by a circuit simulation technique using at least one non-quantum processor; transforming the model of the electronic circuit to a system of equations solvable by at least one quantum computer using the at least one non-quantum processor; solving the system of equations by the at least one quantum computer; and mapping the solution of the system of equations to the modelled electronic circuit. The disclosure further relates to a method of simulating a test and/or measurement instrument.

### TECHNICAL FIELD

The present disclosure relates to methods and systems to simulate an electronic circuit and a test and/or measurement instrument.

### BACKGROUND

Test and/or measurement instruments, such as oscilloscopes or RF spectrum analyzers, are commonly used for many different tasks, including product development and application or product testing. In many such use cases, one would greatly benefit from accurate simulations of sophisticated models of the instrument or routines. Such simulations can be used to optimize the instrument for certain tasks or to analyze measurement uncertainties and limits of the instrument.

However, simulations of sophisticated models of test and/or measurement instruments or routines are often not feasible or, in any case, strongly limited by the available performance of classical computers. This limitation often leads to the use of simplified models, which do not cover all properties of the instrument, or to long simulation times even on high-performance computing clusters.

Likewise, simulations of high-frequency (RF / microwave) electronic circuits and electromagnetic (EM) components are also limited by the performance of classical computers. This limitation leads to long simulation times of complex circuits or large EM components even on high-performance computing clusters, especially since these circuits are typically optimized using simulations. Simulation times are today one of the most critical factors during product development and are expected to become even more important in the future.

It is known that quantum computers, which leverage the principles of quantum mechanics, such as superposition, entanglement, and interference, can solve certain complex problems much faster than classical computers.

### SUMMARY

In view of the above, this disclosure aims to provide an improved method and system for simulating an electronic circuit, an electromagnetic component, and/or a test and/or measurement instrument. In particular, it is an objective to provide a sophisticated simulation of an electronic circuit, an electromagnetic component and/or a test and/or measurement instrument and, at the same time, avoid long simulation times.

These and other objectives are achieved by the solution provided in the enclosed independent claims. Advantageous implementations of the present disclosure are further defined in the dependent claims.

According to a first aspect, the present disclosure relates to a method of simulating an electronic circuit. The method comprises: modelling the electronic circuit by a circuit simulation technique using at least one non-quantum processor; transforming the model of the electronic circuit to a system of equations solvable by a quantum computer using the at least one non-quantum processor; solving the system of equations by the quantum computer; and mapping the solution of the system of equations to the modelled electronic circuit.

This achieves the advantage that a sophisticated (e.g., detailed and accurate) model of the electronic circuit can be simulated within a relatively short simulation time, especially compared to conventional simulation methods. This is largely due to the hybrid approach of using both a non-quantum processor and a quantum computer, which enables simulation of complex models and short simulation times.

The simulated electronic circuit can represent a real-world circuit, e.g. an RF or high-frequency circuit. For instance, the electronic circuit is a part of an electromagnetic component or a test and/or measurement instrument.

The modelling step of the method can be carried out by means of conventional circuit simulation techniques, such as SPICE (Simulation Program with Integrated Circuit Emphasis), FEM (Finite Element Method), harmonic balance methods, or similar simulation methods (FIT, TLM, etc.).

For example, using SPICE, the electronic circuit is simulated by mapping it to a system of differential algebraic equations. Likewise, using FEM methods, EM components can be simulated by mapping them to a system of partial differential equations. Thereby, the differential algebraic or partial differential equations might be expressed as second or higher-order tensors. These differential-algebraic or partial differential equations can then be transformed to the system of equations solvable by the quantum computer by executing a quantum algorithm.

In an implementation form, the method further comprises: mapping the solution of the system of equations to individual properties or parameters of the electronic circuit.

In an implementation form, the method further comprises: adapting at least one physical parameter of a real-world electronic circuit (or a component/instrument comprising such a circuit) based on the mapping of the solution of the system of equations to the modelled electronic circuit. This achieves the advantage that a real-world device can be adapted based on the simulation results. In this way, the electronic circuit or a device containing the circuit can be optimized for a certain task.

For instance, the at least one physical parameter could be an electrical resistance or impedance.

The modelled electronic circuit can represent the real-world electronic circuit.

In an implementation form, the step of solving the system of equations by the quantum computer comprises the steps of: a) initializing the quantum computer, b) executing a quantum algorithm to solve the system of equations, and c) reading-out a result of the algorithm.

In an implementation form, the step of solving the system of equations by the quantum computer further comprises the steps of: d) repeating the steps a) to c) for a number of times to determine a final result.

In an implementation form, the repetition according to step d) is in time or in number of quantum systems of the quantum computer.

In an implementation form, each repetition provides an intermediate result, wherein the final result is determined based on a statistical analysis of the intermediate results. For example, the final result is determined by means of averaging of the intermediate results.

In an implementation form, the step a) of initializing the at least one quantum computer comprises: initializing qubits (quantum bits) of the at least one quantum computer to a defined state, and mapping quantum gates to a physical platform of the at least one quantum computer. In particular, this initialization depends on the physical platform of the at least one quantum system of the quantum computer.

The at least one quantum computer can be realized in different physical platforms and architectures, such as superconducting circuits, NV (nitrogen-vacancy) centers, photonic circuits, quantum (micro-) mechanical oscillators, neutral atoms, Rydberg atoms, or trapped-ion qubits.

The at least one non-quantum processor may comprise at least one CPU, GPU, FPGA, realtime unit, and/or ASIC, in each case with a corresponding software respectively algorithms. The at least one non-quantum processor can be a conventional computer.

In an implementation form, the step b) of executing a quantum algorithm comprises: executing a quantum gate sequence.

In an implementation form, the step b) of executing a quantum algorithm further comprises: detecting a final state of the quantum states of each qubit after and/or during execution of the gate sequence. Detection of the “final state” does not necessarily mean that the quantum mechanical state itself is determined by measurement (e.g. indirectly by state tomography) but is to be understood as detecting the “encoded” information of the finally reached quantum state. Typically, the population of a quantum state is detected. The information may be for a quantum system with a single constitute either “occupied” or “unoccupied”. In case the quantum system comprises several constitutes, also the number occupied and/or unoccupied states and/or the ratio between these can be used.

In an implementation form, the qubits comprise data qubits and/or ancillary qubits.

The ancillary qubits can be adapted for error correction/reading out the population of the state of the other qubits etc. For example, there may also be logical qubits that comprise several physical qubits.

When initializing the at least one quantum computer, the initial states of the constituents of the quantum computer (e.g., qubits) may be determined according to the initial value problem of the differential equations to be solved. This determination could be performed by a conventional computer (e.g., the non-quantum processor).

According to a second aspect, the present disclosure relates to a system for simulating an electronic circuit. The system comprises at least one quantum computer; and at least one non-quantum processor configured to: model the electronic circuit using a circuit simulation technique, and transform the model of the electronic circuit to a system of equations solvable by the at least one quantum computer. The at least one quantum computer is configured to solve the system of equations; wherein the at least one non-quantum processor is configured to map the solution of the system of equations to the modelled electronic circuit.

The system according to the second aspect of the disclosure can be configured to carry out the method according to the first aspect of the disclosure.

According to a third aspect, the present disclosure relates to a method of simulating a test and/or measurement instrument. The method comprises: modelling the test and/or measurement instrument using operational parameters; determining at least one tensor based on the operational parameters and/or on links between the operational parameters in the modelled test and/or measurement instrument; transforming the at least one tensor to a system of equations solvable by at least one quantum computer; solving the system of equations by the at least one quantum computer; and mapping the solution of the system of equations to the modelled test and/or measurement instrument.

The steps of modelling the test and/or measurement instrument, determining the at least one tensor and mapping the solution of the system of equations to the modelled test and/or measurement instrument can be carried out by at least one non-quantum processor.

The test and/or measurement instrument can comprise a single device or a number of devices, e.g., for testing and/or measuring a device-under-test (DUT).

The simulated test and/or measurement instrument can represent a real-world test and/or measurements instrument. For instance, the operational parameters, which are modelled, are extracted from and/or provided by the real-world test and/or measurements instrument.

The tensor can be a matrix (second order tensor) or a tensor of a higher order.

In an implementation form, the method further comprises: generating a settings file for adapting the test and/or measurement instrument based on the mapping of the solution of the system of equations to the modelled test and/or measurement instrument. This achieves the advantage that a real-world test and/or measurement instrument can be adapted based on the simulation results. In this way, the test and/or measurement instrument can be optimized for a certain task.

In addition or alternatively, the settings file can be generated based on the mapping of the solution of the system of equations to the individual properties and/or components.

According to a fourth aspect, the present disclosure relates to a system for simulating a test and/or measurement instrument, comprising: at least one quantum computer; and at least one non-quantum processor. The at least one non-quantum processor is configured to model the test and/or measurement instrument using operational parameters, determine at least one tensor based on the operational parameters and/or on links between the operational parameters in the modelled test and/or measurement instrument, and transform the at least one tensor to a system of equations solvable by the at least one quantum computer. The at least one quantum computer is configured to solve the system of equations; wherein the at least one processor is configured to map the solution of the system of equations to the modelled test and/or measurement instrument.

### BRIEF DESCRIPTION OF THE DRAWINGS

The above-described aspects and implementations are explained in the following description of embodiments with respect to the enclosed drawings:

FIG. 1 shows a flow diagram of a method of simulating an electronic circuit according to an embodiment;

FIG. 2 shows a flow diagram of a method of simulating a test and/or measurement instrument according to an embodiment;

FIG. 3 shows steps of a method of simulating an electronic circuit and/or a test and/or measurement instrument according to an embodiment;

FIG. 4 shows steps of a method of simulating an electronic circuit and/or a test and/or measurement instrument according to an embodiment; and

FIG. 5 shows a schematic diagram of a system for simulating an electronic circuit according to an embodiment.

### DETAILED DESCRIPTION OF EMBODIMENT

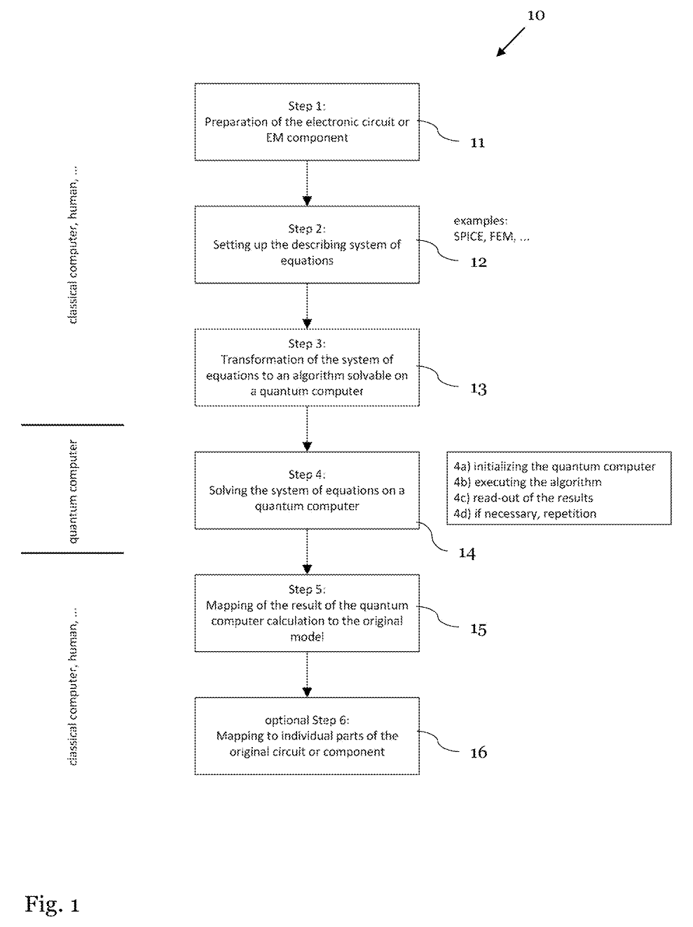

FIG. 1 shows a flow diagram of a method 10 of simulating an electronic circuit according to an embodiment. The electronic circuit can be a part of an electromagnetic (EM) component or device.

The method 10 comprises the steps of: modelling 11, 12 the electronic circuit by a circuit simulation technique using at least one non-quantum processor; transforming 13 the model of the electronic circuit to a system of equations solvable by at least one quantum computer using the at least one non-quantum processor; solving 14 the system of equations by the at least one quantum computer; and mapping 15 the solution of the system of equations to the modelled electronic circuit.

The method 10 takes advantage of the fact that quantum computers have a strong advantage over classical computers for calculating certain algorithms, in particular in terms of calculation speed and possible complexity of the calculation. This is utilized by solving 14 the system of equations, which represents the model of the electronic circuit, on the quantum computer.

The at least one quantum computer can be realized in different physical platforms and architectures, such as superconducting circuits, NV (nitrogen-vacancy) centers, photonic circuits, quantum (micro-) mechanical oscillators, neutral atoms, Rydberg atoms, or trapped-ion qubits.

The at least one non-quantum processor can be a conventional processor. For example, the at least one non-quantum processor comprises at least one CPU, GPU, FPGA, real-time unit, and/or ASIC, in each case with a corresponding software respectively algorithms.

For instance, one non-quantum processor can be connected to a plurality of quantum computers. In other words: The number of quantum computers and non-quantum computers can be different.

The simulated electronic circuit can represent a real-world electronic circuit. For instance, the electronic circuit is an RF and/or high-frequency circuit.

The step 1 of modelling the electronic circuit can comprise the sub-steps of: preparing 11 (e.g., defining parameters and/ properties) of the electronic circuit, and generating 12 a corresponding system of equations. This system of equations can comprise a set of differential equations which represent the electronic circuit. For instance, these differential equations comprise non-linear differential-algebraic equations (DAEs) and/or non-linear partial differential equations (PDEs). The thus generated system of equations can be subsequently transformed to the (further) system of equations solvable by the at least one quantum computer in step 13 (executing a quantum algorithm).

For example, the modelling of steps 11-12 can be carried out by means of conventional circuit simulation techniques, such as SPICE (Simulation Program with Integrated Circuit Emphasis), FEM (Finite Element Method), harmonic balance methods, or similar simulation methods (FIT, TLM, etc.).

The systems of equations which can be solved by a to quantum algorithm (generated in step 13) can comprise high-dimensional non-linear differential-algebraic and/or non-linear partial differential equations

For instance, a nonlinearity of the differential equations (provided e.g. by SPICE) is expressed in the quantum-computer solvable system of equations by a Hamiltonian simulation with a truncated Taylor expansion. An example for such a transformation according to step 13 in the context of differential-algebraic equations is given in the scientific publication Tran, Huynh TT, et al. "Solving differential‐algebraic equations in power system dynamic analysis with quantum computing." Energy Conversion and Economics 5.1 (2024): 40-53.

The steps 11, 12, 13 and/or 15 of the method 10 may be carried out by the at least one non-quantum processor of, e.g., a conventional computer. The conventional computer can model the test and/or measurement instrument by different means (step 1).

For instance, step 14 of the method 10 refers to an execution of a quantum algorithm on the at least one quantum computer. This step 14 may comprise a number of sub-steps, namely: initializing 4a the quantum computer, executing 4b a quantum algorithm to solve the system of equations, and reading-out 4c the results of the algorithm. Optionally, the sub-steps further comprise repeating 4d the previous steps 4a-4c for a number of times to calculate a final result.

For example, the repetition according to step 4d is in time or in number of quantum systems of the at least one quantum computer. Each quantum computer can comprise a plurality of quantum systems which can operate in parallel or consecutively.

For example, a repetition in time can be a periodic repetition (e.g., a repetition every 10 seconds) and a repetition in quantum systems can be a repetition of the execution of the same algorithm in different quantum systems. By means of this repetition, a more accurate final result can be achieved. The number of repetitions 4d may be based on statistical considerations of fundamental quantum mechanics and/or a likelihood of arriving at a correct result.

Each repetition 4d may provide an intermediate result, wherein the final result is calculated based on a statistical analysis of the intermediate results, for instance by averaging the intermediate results.

After carrying out step 14, the solution of the quantum computation may be available in the form of classical information, which can then be mapped back to the original model of the electronic circuit. This can again be done by the use of the conventional computer (step 5). The model may comprise the operational parameters and the tensors.

A further optional step of the method 10 comprises a mapping 6 of the solution of the system of equations to individual properties or parts of the electrical circuit. In particular, step 6 may refer to a determining of these properties or parts based on the solution of the system of equations.

For instance, the parameters can be parameters of components of the circuit, e.g. of its circuit components or measurement paths, or can represent properties of the electronic circuit. Based on the determined parameters, the electronic circuit can be optimized for a certain measurement task and/or configuration.

The method 10 could be evolved further by including optimization routines. These optimization routines can either be performed completely on the conventional computer or can use so-called hybrid classical-quantum optimization techniques, for example, QAOAs (Quantum Approximate Optimization Algorithms) or run completely on the quantum computer. For example, in simulations of integrated circuits, the arrangement of transistors in relation to each other and their respective properties are optimized. This would be very computationally intensive on conventional computers. Using techniques such as QAOA, such optimization problems can be solved in a more efficient manner.

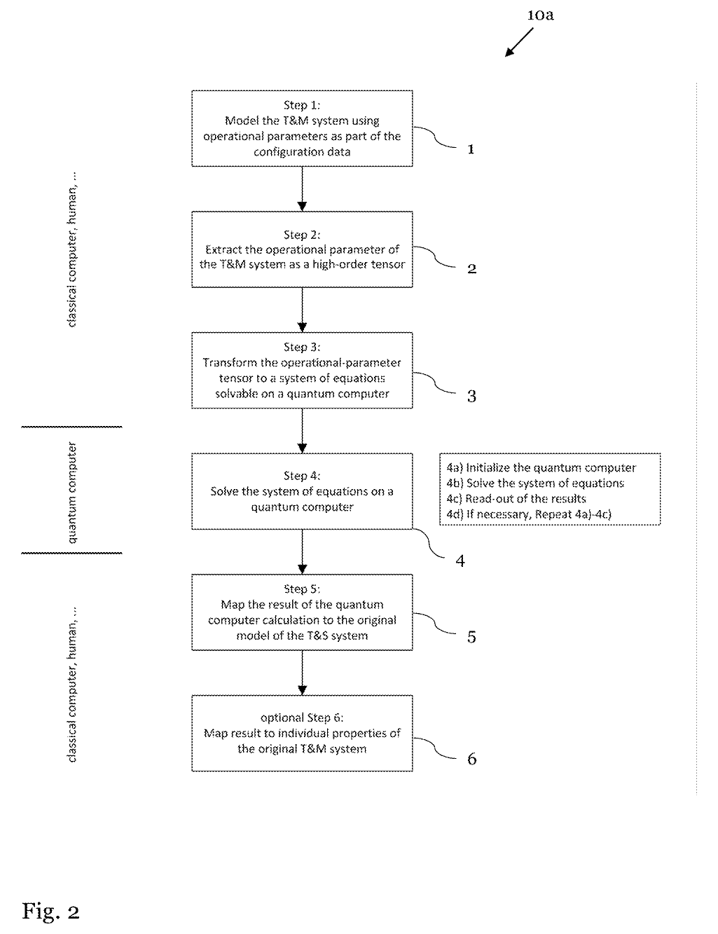

FIG. 2 shows a further flow diagram of a method 10a for simulating a test and/or measurement instrument according to an embodiment.

The method 10a comprises the steps of: modelling 1 the test and/or measurement instrument using operational parameters; determining 2 at least one tensor based on the operational parameters and/or on links between the operational parameters in the modelled test and/or measurement instrument; transforming 3 the at least one tensor to a system of equations solvable by at least one quantum computer; solving 4 the system of equations by the at least one quantum computer; and mapping 5 the solution of the system of equations to the modelled test and/or measurement instrument.

The step of modeling 1 the test and/or measurement instrument may be equivalent to steps 11 and 12 of the method 10 as shown in FIG. 1. For instance, this step comprises using a conventional computer and/or conventional simulation methods, such a SPICE (Simulation Program with Integrated Circuit Emphasis), FEM (Finite Element Method), harmonic balance methods, or similar simulation methods (FIT, TLM, etc.) to model the system of equations which describes the test and/or measurement instrument. Another example are regression methods (e.g. linear curve fits) describing dependencies between all or parts of the tensor elements, which can be mapped to a system of equations solvable by a quantum algorithm. A conventional computer may be used for these steps, as these preparations are not computational expensive.

The test and/or measurement instrument can comprise a single device or a number of devices, e.g., for testing and/or measuring a device-under-test (DUT). For instance, the test and/or measurement instrument is a T&M device or system. The test and/or measurement instrument may thereby comprise or be one of complex electronic circuits and/or electromagnetic (EM) components.

For instance, the operational parameters, which are modelled, are extracted from and/or provided by the real-world test and/or measurements instrument. These parameters can be provided to the at least one processor by means a user input (e.g., on a user interface connected to the processor) or via a communication interface.

The test and/or measurement instrument may comprise any combination of the following devices: an audio analyzer, a cellular network analyzer, a control and monitoring system, a device for EMC and field strength testing, a direction finder, a microwave imaging device, a mobile network testing device, a meter and/or counter, a network analyzer, an optical measurement device, an oscilloscope, a power meter and/or voltmeter, a radar echo generator, a receiver, a satellite monitoring device, a signal analysis device, a signal and spectrum analyzer, a signal generator, and a wireless communications tester and/or instrument.

The operational parameters may comprise any combination of the following parameters: frequency range, level range, phase noise range, dynamic range, linearity (e.g., compression point, intermodulation), time resolution, level resolution, frequency resolution, power requirement for the measurement, bandwidth, error-vector-magnitude (EVM) vs. input level / frequency, measurement speed, demodulation method, calibration method, standards (e.g., which standard does the instrument fulfill), measurement application (e.g., can the instrument pulse or not), amplification (e.g., linear amplification), and measurement path (which is used for the measurement).

The model(s) of the test and/or measurement instrument may use(s) the operational parameters as part of configuration data. The configuration data may describe electrical and/or mechanical and/or environmental (e.g. humidity or temperature) and/or software properties of the test and/or measurement instrument.

For example, the operational parameters of the test and/or measurement instrument (or links between said parameters) can be extracted from the model as a tensor or non-sparse matrix without loss of generality (step 2). The tensor or non-spares matrix can then be transformed (step 3) to the system of equations which is solvable by the at least one quantum computer.

The tensor is a multidimensional array. For instance, the tensor is a matrix or a higher-order tensor which generalizes the concept of matrices to higher dimensions (third-order or more). The tensor can enable the modeling and analysis of complex relationships and interactions between the operational parameters of the test and/or measurement instrument. For instance, the tensor may be a set of correlated data describing measurement properties of the test and/or measurement instrument and their dependencies with respect to parameters of the instrument, especially settings or properties of applied signals to be measured.

The remaining steps 4 to 6 can be equivalent to steps 14 to 16 of the method 10 as shown in FIG. 1 and explained above.

By means of the above described methods 10 and 10a, simulation times can be reduced and sophisticated models, which are impossible or at least difficult to simulate with conventional means, can be efficiently simulated. For instance, compared to machine learning or artificial intelligence approaches to model electronic circuits and/or T&M instruments, the quantum computer algorithm is able to simulate the circuit and/or instrument models in a deterministic way (similar to today's classical computers). This makes it possible to comprehensible understand the individual calculation steps which lead to the final result and thus allows to obtain deeper knowledge of the circuit and/or instrument. Furthermore, statistical uncertainties or noise of the input parameters of the circuit and/or instrument can be propagated in the simulations and a statistical analysis can be performed to obtain confidence intervals on the resulting parameters.

According to an example, a quantum computing system for simulating an electronic circuit may comprise: a quantum processor capable of performing quantum operations on quantum bits (qubits); a quantum circuit encoder configured to convert an electronic circuit design into a quantum state representation; a quantum simulation engine adapted to execute quantum operations on the quantum state representation of the electronic circuit to simulate the circuit behavior; a measurement system to measure the quantum state after simulation and produce output corresponding to the circuit's real-world behavior; and a classical processing unit for interpreting quantum measurement results and providing simulation outputs.

According to a further example, a method for simulating an electronic circuit using quantum computing, may comprise the steps of: encoding the electronic circuit, including components, connections, and logic operations, into a quantum state representation; initializing at least one quantum computer with the encoded quantum state representation of the electronic circuit; performing quantum operations on the initialized quantum state to simulate the behavior of the circuit components, including the quantum evolution of individual components and their interactions; measuring the quantum state of the system after quantum operations to obtain output values corresponding to the output of the simulated electronic circuit; interpreting the quantum measurement results and converting them into classical values that represent the corresponding real-world output of the electronic circuit; repeating the quantum operations for different input conditions and circuit configurations, adjusting the quantum state representation accordingly, to obtain simulation results for a range of operating conditions of the electronic circuit; outputting the results of the simulated electronic circuit, providing insights into the performance and characteristics of the circuit design based on quantum computing simulations.

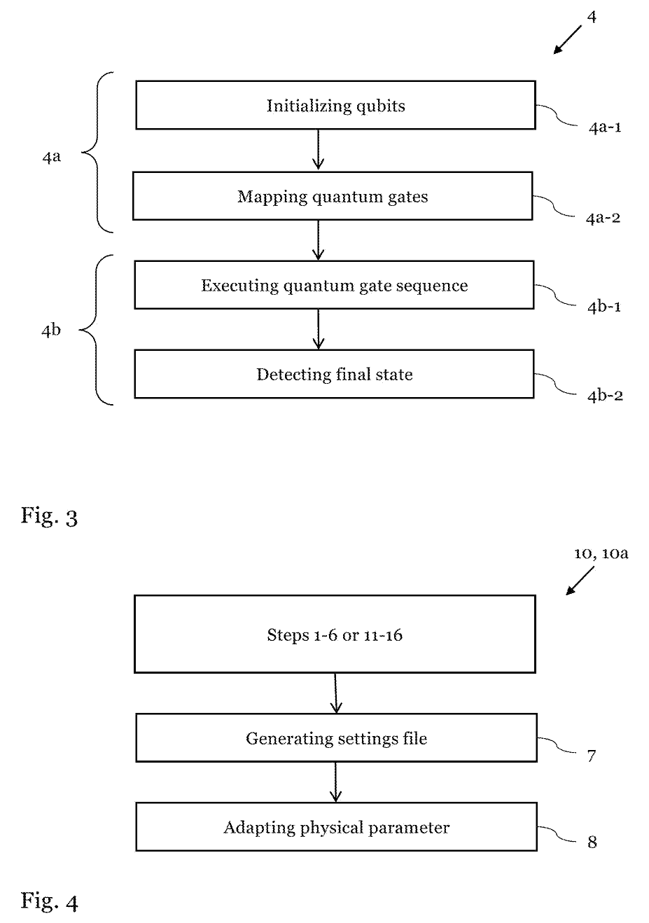

FIG. 3 shows further steps of the methods 10, 10a according to an embodiment. In particular, FIG. 3 shows sub-steps of step 14 respectively 4 (solving the system of equations with the at least one quantum computer).

The step a) of initializing the at least one quantum computer may comprise: initializing 4a-1 qubits (quantum bits) of the at least one quantum computer to a defined state, and mapping 4a-2 quantum gates to the physical platform of the at least one quantum computer. Thereby, a selection of the physical platform determines this initialization.

The quantum gates can be fundamental operations on a number of qubits of the quantum system. For instance, the quantum gates can be realized using RF and/or microwave and/or laser pulses. Sequencing a number of quantum gates forms a quantum algorithm (via time/qubits). Alternatively, in an analog quantum computing approach, the system of equations which describes the electronic circuit and/or T&M system can be converted into coefficients of an Hamiltonian for solving the Schrödinger equation and the quantum computer is configured to use this Hamiltonian during or for computation. For e.g. simulations of time-dependent problems, the analog quantum computer is initialized so that the states of quantum computer match the initial conditions of the system of equations to be solved.

By means of this initialization 4a, it can be made sure that the starting conditions for simulation carried out by the at least one quantum computer are correct.

The step 4b of executing the quantum algorithm may comprise: executing 4b-1 a quantum gate sequence and detecting 4b-2 a final state of the quantum states of each qubit after and/or during execution of the gate sequence. Detection of the “final state” does not necessarily mean that the quantum mechanical state itself is determined by measurement (e.g. indirectly by state tomography) but is to be understood as detecting the “encoded” information of the finally reached quantum state. Typically, the population of a quantum state is detected. The information may be for a quantum system with a single constitute either “occupied” or “unoccupied”. In case the quantum system comprises several constitutes, also the number occupied and/or unoccupied states and/or the ratio between these can be used.

The qubits of the at least one quantum computer may comprise data qubits and/or ancillary qubits. The ancillary qubits can be adapted for error correction/reading out the population of the state of the other qubits etc. For example, there may also be logical qubits that comprise several physical qubits.

When initializing the at least one quantum computer, the initial states of the constituents of the quantum computer (e.g., qubits) may be determined according to the initial value problem of the differential equations to be solved. This determination could be performed by a conventional computer.

FIG. 4 shows further steps of the methods 10, 10a of simulating the electronic circuit and/or test and/or measurement instrument according to an embodiment.

For example, the method 10a can comprise the further step of: generating 7 a settings file for adapting the test and/or measurement instrument based on the mapping of steps 5 and/or 6 (respectively steps 15 and/or 16).

The setting file can comprise settings for the real-world test and/or measurement instrument based on which the simulation was carried out. The setting file can comprise instructions for adapting this (real-world) instrument.

In addition or alternatively, the methods 10a, 10 may comprise the step of: adapting 8 at least one physical parameter of the real-world electronic circuit and/or test and/or measurement instrument based on the mapping of steps 5 and/or 6 (respectively step 15 and/or 16).

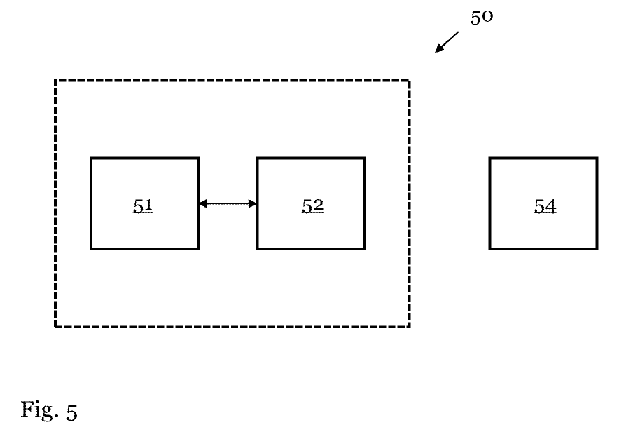

FIG. 5 shows a schematic diagram of a system 50 for simulating the electronic circuit 54 according to an embodiment.

The system 50 comprises at least one quantum computer 52 and at least one non-quantum processor 51, wherein the non-quantum processor 51 is configured to model the electronic circuit using the circuit simulation technique, transform the model of the electronic circuit to the system of equations solvable by the at least one quantum computer 52, wherein the at least one quantum computer 52 is configured to solve the system of equations. The at least one processor 51 is further configured to map the solution of the system of equations of the modelled electronic circuit 54.

The system 50 can thus be a hybrid classical and quantum simulation system, wherein calculations to be carried out are allocated to the at least one quantum computer 52 or the at least one processor 51 (e.g., of a conventional computer), depending which of these “computers” is more suitable.

The number of quantum computers and non-quantum processor of the system can be different. For instance, one non-quantum processor can be connected to several quantum computers. For instance, the quantum algorithm can run in parallel on several quantum computers for performing averaging.

A corresponding system for simulating a test and/or measurement instrument can comprise a non-quantum processor configured to carry out the steps 1-3 and 5 (and optionally 6) of the method 10a shown in FIG. 2, and a quantum computer configured to carry out the step 4 of the method 10a shown in FIG. 2.

What is claimed is:

1. A method of simulating an electronic circuit, comprising:
modelling the electronic circuit by a circuit simulation technique using at least one non-quantum processor;
transforming the model of the electronic circuit to a system of equations solvable by at least one quantum computer using the at least one non-quantum processor;
solving the system of equations by the at least one quantum computer; and
mapping the solution of the system of equations to the modelled electronic circuit.

2. The method of claim 1, further comprising:
mapping the solution of the system of equations to individual properties or parameters of the electronic circuit.

3. The method of claim 1, further comprising:
adapting at least one physical parameter of a real-world electronic circuit based on the mapping of the solution of the system of equations to the modelled electronic circuit.

4. The method of claim 1,
wherein the step of solving the system of equations by the at least one quantum computer comprises the steps of:
a) initializing the at least one quantum computer;
b) executing a quantum algorithm to solve the system of equations, and
c) reading-out a result of the algorithm.

5. The method of claim 4,
wherein the step of solving the system of equations by the at least one quantum computer further comprises the step of:
d) repeating the steps a) to c) for a number of times to determine a final result.

6. The method of claim 5,
wherein the repetition according to step d) is in time or in number of quantum systems of the quantum computer.

7. The method of claim 5,
wherein each repetition provides an intermediate result, wherein the final result is determined based on a statistical analysis of the intermediate results.

8. The method of claim 4,
wherein the step a) of initializing the at least one quantum computer comprises:
initializing qubits of the at least one quantum computer to a defined state, and
mapping quantum gates to the physical platform of the at least one quantum computer.

9. The method of claim 8,
wherein the step b) of executing the quantum algorithm comprises:
executing a quantum gate sequence.

10. The method of claim 9,
wherein the step b) of executing the quantum algorithm further comprises:
detecting a final state of the quantum states of each qubit after and/or during execution of the gate sequence.

11. The method of claim 8,
wherein the qubits comprise data qubits and/or ancillary qubits.

12. The method of claim 8,
wherein, when initializing the at least one quantum computer, initial states of constituents of the quantum computer, e.g. qubits, are determined according to an initial value problem of a differential equation to be solved.

13. A system for simulating an electronic circuit, comprising:
at least one quantum computer; and
at least one non-quantum processor configured to:
model the electronic circuit using a circuit simulation technique,
transform the model of the electronic circuit to a system of equations solvable by the at least one quantum computer;
wherein the at least one quantum computer is configured to solve the system of equations; and
wherein the at least one processor is configured to map the solution of the system of equations to the modelled electronic circuit.

14. The system of claim 13,
wherein the at least one processor is further configured to map the solution of the system of equations to individual properties or parameters of the electronic circuit.

15. The system of claim 13,
wherein the at least one processor is further configured to adapt at least one physical parameter of a real-world electronic circuit based on the mapping of the solution of the system of equations to the modelled electronic circuit.

16. The system of claim 13,
wherein the step of solving the system of equations by the at least one quantum computer comprises the steps of:
a) initializing the at least one quantum computer;
b) executing a quantum algorithm to solve the system of equations, and
c) reading-out a result of the algorithm.

17. The system of claim 15,
wherein the step of solving the system of equations by the at least one quantum computer further comprises the step of:
d) repeating the steps a) to c) for a number of times to determine a final result.

18. The system of claim 17,
wherein the repetition according to step d) is in time or in number of quantum systems of the quantum computer.

19. A method of simulating a test and/or measurement instrument, comprising:
modelling the test and/or measurement instrument using operational parameters;
determining at least one tensor based on the operational parameters and/or on links between the operational parameters in the modelled test and/or measurement instrument;
transforming the at least one tensor to a system of equations solvable by at least one quantum computer;
solving the system of equations by the at least one quantum computer; and
mapping the solution of the system of equations to the modelled test and/or measurement instrument.

20. The method of claim 17, further comprising:
generating a settings file for adapting the test and/or measurement instrument based on the mapping of the solution of the system of equations to the modelled test and/or measurement instrument.
